(19) United States
(12) Patent Application Publication
(10) Pub. No.: US 2021/0135700 A1
(43) Pub. Date: May 6, 2021

(54) PROTECTIVE CASE

(71) Applicant: Shenzhen Okut Electronic Technology Co., Ltd, Shenzhen, (CN)

(72) Inventor: Bo Duan, Shenzhen (CN)

(21) Appl. No.: 16/742,927

(22) Filed: Jan. 15, 2020

(30) Foreign Application Priority Data
Nov. 1, 2019 (CN) 201921874965.8

(51) Int. Cl. H04B 1/3888

(52) U.S. Cl. CPC H04B 1/3888

(57) ABSTRACT

A protective case is provided with a connector at an inner side thereof. The connector is used for connecting to an interface of an equipment to be protected. A function module is provided in the protective case and electrically connected with the interface. Ports are provided on one side of the protective case and electrically connected with the connector. It can be connected with the interface of an equipment such as a mobile phone or a tablet computer. An outer side of the protective case is provided with ports that are the same or adaptable with the interfaces of the mobile phone or tablet computer.

### CROSS REFERENCE TO RELATED APPLICATIONS

The present application claims the benefit of Chinese Patent Application No. 201921874965.8 filed on Nov. 1, 2019, the contents of which are incorporated herein by reference in their entirety.

### TECHNICAL FIELD

The present disclosure relates to the technical field of smart equipment, and particularly relates to a protective case.

### BACKGROUND

A protective case is used to cover the outside of an outer housing of a notebook computer, a tablet computer or a mobile phone, and produces a protective effect.

However, at the same time of using the protective case, it also increases the thickness between its interface and the data wire and earphone wire connector. Especially when using other external function expander or adding function modules, its thickness increases and causes problems such as poor contact, unstable charging, unstable plugging and even not being able to use directly.

### SUMMARY

In order to overcome the shortcomings of the prior art, an object of the present disclosure is to provide a protective case with a function module that is stable in charging and more stable in inserting and removing.

The present disclosure is realized through the following technical measures. The protective case is provided with a connector at an inner side thereof. The connector is used for connecting with an interface of an equipment to be protected. A function module is provided in the protective case and electrically connected with the interface. Ports are provided on one side of the protective case and electrically connected with the connector.

As a preferred mode, the connector includes a lightning dock connector, or a micro USB connector, or a Type-C connector.

As a preferred mode, the ports include a lightning dock interface, a micro USB interface, a Type-C interface, and an earphone interface.

As a preferred mode, the function module includes a display module and a sound module.

As a preferred mode, the function module further includes a storage module.

As a preferred mode, the protective case is provided with a slider device. The connector and the ports are located on the slider device. The slider device controls the connection and disconnection of the connector and the interface by sliding.

As a preferred mode, the slider device is formed with sliding troughs, and the protective case is formed with sliding pieces that fit with the sliding troughs. The slider device is slidably connected to the protective case along the sliding pieces.

As a preferred mode, two sides of the slider device are formed with indentations, and two sides of the protective case are formed with through-holes that correspond to the position of the indentations.

As a preferred mode, poking notches are formed on the slider device at one end thereof near the connector.

As a preferred mode, one side of the protective case is provided with a foldable screen cover.

The protective case provided by the present disclosure can be connected with the interface of an equipment such as a mobile phone or a tablet computer. An outer side of the protective case is provided with ports that are the same or adaptable with the interfaces of the mobile phone or tablet computer. This solves the problems of poor contact during charging and even not being able to use due to the increase in thickness at the interface region of the mobile phone or tablet computer as a result of the addition of a function module after the use of a protective case.

### BRIEF DESCRIPTION OF THE DRAWINGS

FIG. 1 is a perspective view of an embodiment of the structure of the present disclosure;

FIG. 2 is an exploded view of an embodiment of the structure of the present disclosure;

FIG. 3 is a front view of an embodiment of the present disclosure; and

FIG. 4 is a right side view of an embodiment of the present disclosure.

FIG. 5 is a partial enlarged view of an embodiment of the present disclosure.

Reference numerals and names in the figures: 1 protective case, 11 screen cover, 12 sliding piece, 13 through-hole, 2 function module, 21 display module, 22 sound module, 3 connector, 4 port, 41 earphone interface, 42 type-C interface, 43 micro USB interface, 44 lightning dock interface, 5 slider device, 51 sliding trough, 52 indentation, 53 poking notch.

### DETAILED DESCRIPTION

The present disclosure will be further described in conjunction with the following embodiments and the accompanying drawings.

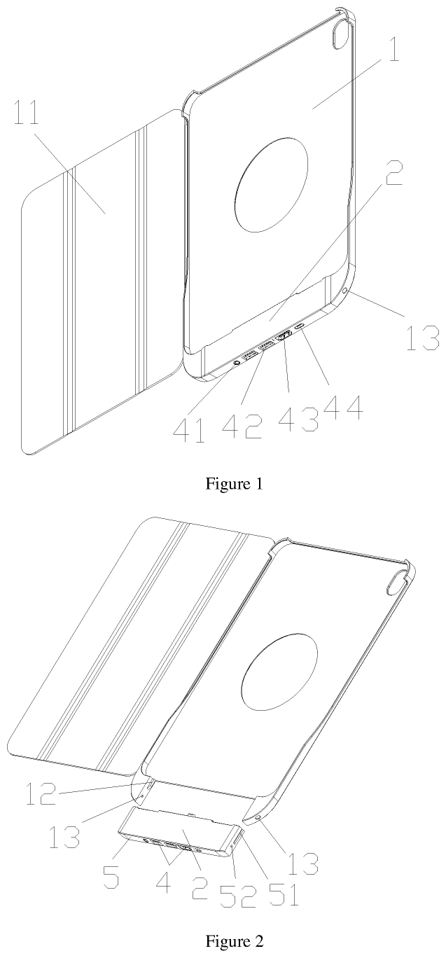

Referring to FIGS. 1-5, a protective case 1 can wrap around the body of a smart equipment such as a mobile phone or a tablet computer, and expose its operation interface such as the screen. An inner side of the protective case 1 near an interface of the equipment to be protected may be provided with a connector 3, which can be connected to the interface. A function module 2 may be provided in the protective case 1. The function module 2 can be used for carrying out real time data communication with the equipment to be protected. One side of the protective case 1 may be provided with ports 4 which are electrically connected with the connector 3. The ports 4 can be used for connecting with external lines.

Through the connector 3 provided at the inner side of the protective case 1, the present protective case can be connected with the interfaces of a mobile phone or a tablet computer. An outer side of the protective case may be provided with ports 4 that are the same or adaptable with the interfaces of the mobile phone or the tablet computer. This solves the problems of poor contact during charging and even not being able to use due to the increase in thickness at the interface region of the mobile phone or tablet computer as a result of the addition of a function module after the use of the protective case.

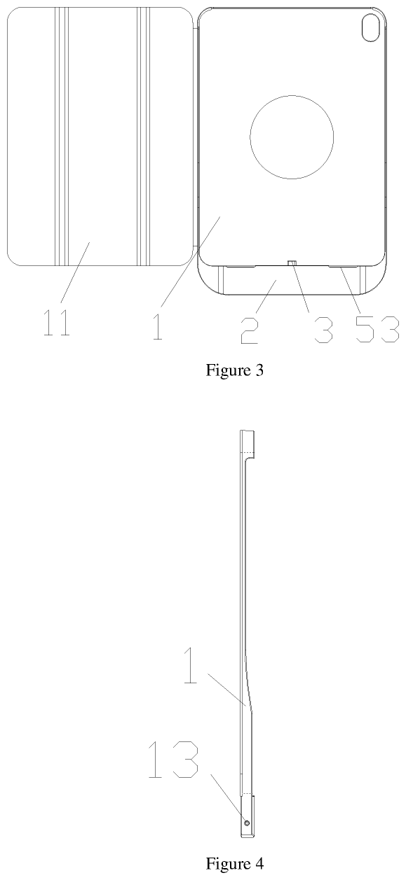

In one embodiment, as shown in FIG. 2 and FIG. 3, the connector 3 may include a lightning dock connector, or a micro USB connector, or a Type-C connector, and may further include an earphone connector to adapt with the interface of different mobile phones and tablet computers.

In one embodiment, as shown in FIG. 1, the ports 4 may include a lightning dock interface 44, a micro USB interface 43, a Type-C interface 42, and an earphone interface 41 such that its adaptability is stronger. This can avoid the problem of failure of normal usage when there is no suitable or adaptable data wire.

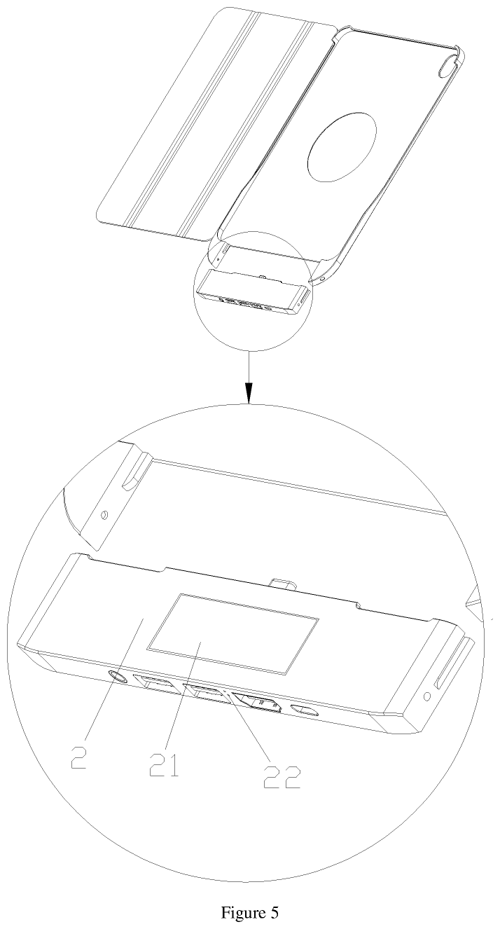

In one embodiment, as shown in FIG. 5, the function module 2 may include a display module 21 and a sound module 22. The display module 21 can be used to display the time, or the display module 21 can be located at the back of the protective case. It can display various changes and combinations of light according to a user's needs. The sound module 22 can be used to prompt the connection and interruption of the function module and the equipment, and remind the user of the usage modes of the mobile phone, tablet computer, or other equipment. When the sound module 22 is in operation, the display module 21 can display different changes and combinations of light in real time according to the changes of sound of the sound module in order to enhance user experience.

In one embodiment, the function module 2 may further include a storage module for storing data required during operation of the display module and the sound module, and for using the protective case as a mobile storage equipment.

In one embodiment, as shown in FIG. 2 and FIG. 3, the protective case 1 is provided with a slider device 5. The connector 3, the ports 4, and the function module 2 may be located on the slider device 5. The slider device 5 may be formed with sliding troughs 51, and the protective case 1 may be formed with sliding pieces 12 that can fit with the sliding troughs 51. The slider device 5 can be slidably connected to the protective case 1 along the sliding pieces 12. The slider device 5 can control the connection and disconnection of the connector 3 and the equipment such as a mobile phone or a tablet computer by sliding. When the protective case 1 is metal, it is not easy to install and connect the mobile phone or tablet computer with the connector 3. Therefore, by using a slider device, a user can slide the slider device 5 out, put the mobile phone or tablet computer in the protective case 1, and then push the slider device 5 in so that the connector 3 is connected to the interface of the equipment. This makes the usage and installation process more convenient.

In one embodiment, as shown in FIG. 2, two sides of the protective case 1 may be formed with through-holes 13. The slider device 5 may be formed with indentations 52. Inserting pins can be inserted in order to fix the slider device 5.

In one embodiment, as shown in FIG. 2, poking notches 53 are provided on the slider device 5 at one end thereof near the connector 3. When the slider device 5 is connected to the equipment such as a mobile phone or a tablet computer, it is abutted closely against the equipment. The connector 3 is inserted into the interface of the equipment and it requires a user to exert a certain amount of force to take it out. Fingers can be used to poke the poking notches in order to move the slider device 5 out and unplug the connector 3.

In one embodiment, as shown in FIGS. 1-3, one side of the protective case 1 is provided with a foldable screen cover 11. When not in use, it can protect a screen of the mobile phone or tablet computer.

The above is an explanation of the protective case of the present disclosure which helps to understand the present disclosure. However, the embodiments of the present disclosure are not limited by the foregoing embodiments. Any changes, modification, substitution, combination, and simplification made without departing from the principle of the present disclosure should all be equivalent replacements and should all be included in the scope of protection of the present disclosure.

What is claimed is:

1. A protective case, comprising a connector provided at an inner side of the protective case, the connector being used for connecting with an interface of an equipment to be protected; a function module provided in the protective case and electrically connected with the interface; ports provided on one side of the protective case and electrically connected with the connector.

2. The protective case according to claim 1, wherein the connector comprises a lightning dock connector, or a micro USB connector, or a Type-C connector.

3. The protective case according to claim 2, wherein the ports comprise a lightning dock interface, a micro USB interface, a Type-C interface, and an earphone interface.

4. The protective case according to claim 1, wherein the function module comprises a display module and a sound module.

5. The protective case according to claim 4, wherein the function module further comprises a storage module.

6. The protective case according to claim 1, wherein the protective case is provided with a slider device, the connector and the ports being located on the slider device, and the slider device controls the connection and disconnection of the connector and the interface by sliding.

7. The protective case according to claim 6, wherein the slider device is formed with sliding troughs, the protective case is formed with sliding pieces that fit with the sliding troughs, and the slider device is slidably connected to the protective case along the sliding pieces.

8. The protective case according to claim 7, wherein two sides of the slider device are formed with indentations, and two sides of the protective case are formed with through-holes that correspond to the position of the indentations.

9. The protective case according to claim 8, wherein poking notches are formed on the slider device at one end thereof near the connector.

10. The protective case according to claim 1, wherein one side of the protective case is provided with a foldable screen cover.
